(19) United States
(12) Patent Application Publication
(10) Pub. No.: US 2021/0352075 A1
(43) Pub. Date: Nov. 11, 2021

(54) GROUP IDENTIFICATION USING MACHINE LEARNING

(71) Applicant: Apple Inc., Cupertino, CA (US)

(72) Inventors: Gokul P. THIRUMALAI, Mountain View, CA (US); Chiraag SUMANTH, Mountain View, CA (US); Yuanlong CHEN, Sunnyvale, CA (US); Joao Pedro DE ALMEIDA FORJAZ DE LACERDA, Santa Cruz, CA (US)

(21) Appl. No.: 17/092,147

(22) Filed: Nov. 6, 2020

Related U.S. Application Data
(60) Provisional application No. 63/022,352, filed on May 8, 2020.

(51) Int. Cl. H04L 29/06; G06N 20/00

(52) U.S. Cl. CPC H04L 63/104; G06N 20/00; H04L 63/102

(57) ABSTRACT

The subject disclosure provides a machine learning engine trained to recommend, from contacts on a user's device, potential group members to be included in a group with the user. The potential group members can be identified in a privacy preserving manner in which the identification is performed locally at the user's device, using data that is locally stored at the user device. In one or more implementations, a remote server may provide an initial indication to the user's device that potential group members may exist, thereby triggering the local identification of the potential group members for suggestion to the user.

### CROSS REFERENCE TO RELATED APPLICATIONS

This application claims the benefit of priority to U.S. Provisional Patent Application No. 63/022,352, entitled “Group Identification Using Machine Learning,” filed on May 8, 2020, the disclosure of which is hereby incorporated herein in its entirety.

### TECHNICAL FIELD

The present description relates generally to account sharing for electronic devices.

### BACKGROUND

Users of electronic devices typically have one or more user accounts with one or more servers that communicate with the electronic devices. The user accounts can be associated with applications on an electronic device, secure storage for content generated with an electronic device of the user, streaming services for the user, and the like. Each user of each device typically has their own account for accessing the applications, content, and services.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that includes a connected home environment containing user devices in accordance with one or more implementations.

FIG. 2 illustrates an example device that may implement a system for identifying group members for account sharing in accordance with one or more implementations.

FIG. 3 illustrates various user devices and various user accounts accessible by various users in accordance with one or more implementations.

FIG. 4 illustrates a recommendation of a potential group member that can be provided to a user of an electronic device in accordance with one or more implementations.

FIG. 5 illustrates a flow diagram of an example process for identifying group members for account sharing in accordance with one or more implementations.

FIG. 6 illustrates a flow diagram of an example process for providing a portion of a list of contacts to a machine learning model at a user device in accordance with one or more implementations.

FIG. 7 illustrates a flow diagram of an example process for adding an identified group member to a group in accordance with one or more implementations.

FIG. 8 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The subject technology provides machine learning models trained to use content that is local to a user's own device to identify potential group members for group sharing of applications, data, services, and/or content. Groups may include family groups, coworker groups, friend groups or the like.

In one or more implementations, initial identification of eligibility of a first user for group sharing can be determined by a server at which the user and another user have respective user accounts. In these implementations, once eligibility of the first user is determined at the server, the server instructs the user's device to perform on-device operations, such as machine learning operations, to identify potential group members. The user's device may perform the machine learning operations using content that is locally generated and/or stored at the user's device, to identify one or more potential group members for the user. The user's device may also use explicit trust signals at the user's device to verify a potential family member before suggesting sharing with that potential family member. Operations can be used for groups other than families.

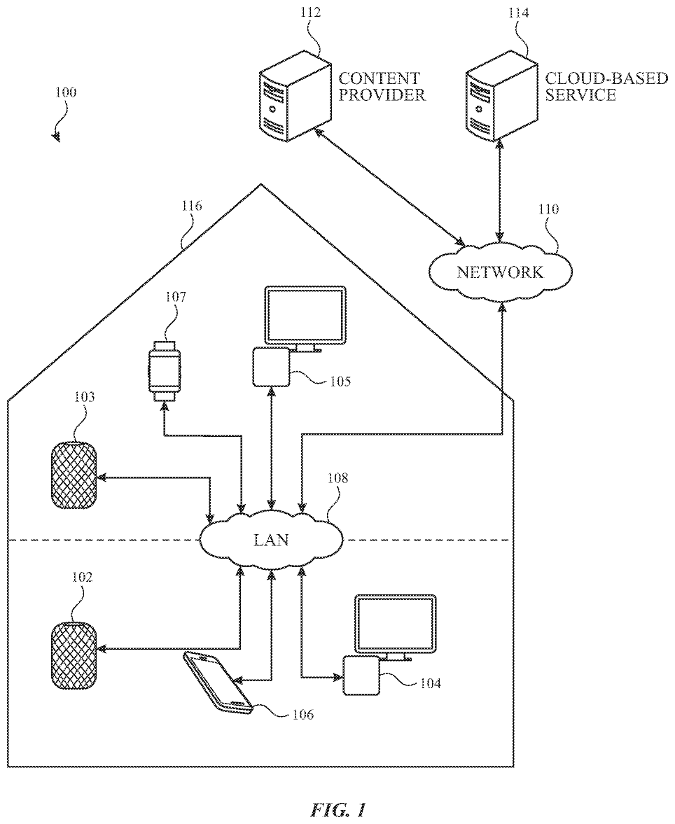

FIG. 1 illustrates an example network environment 100 that includes various devices in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes electronic devices 102, 103, 104, 105, 106 and 107 (hereinafter “the electronic devices 102-107”), a local area network (“LAN”) 108, a network 110, and a content provider 112 and one or more cloud-based service(s) 114 (hereinafter “the servers 112-114”).

Content provider 112 may provide access to content such as streaming content (e.g., video content, audio content) or other subscription-based content (e.g., electronic book content or the like) to user devices (e.g., to one or more of the electronic devices 102-107) that are associated with a user account that has been established with the content provider 112. Cloud-based service 114 may provide access to cloud-based storage, content (e.g., photos, videos, calendar information, etc.) stored in the cloud-based storage, applications (e.g., gaming applications, streaming applications, and/or any other application) to user devices (e.g., to one or more of the electronic devices 102-107) that are associated with a user account that has been established with the cloud-based service 114. Users of the electronic devices 102-107 may provide authentication information to that device, to log that device into one or more accounts that are maintained for that user at one or more of the servers 112-114).

In accordance with aspects of the subject disclosure, one or more of the servers 112-114 can provide group accounts that can grant multiple group members in the group access to the same applications, content, storage, photos, calendars, etc. However, it can be challenging to identify potential group members for group accounts, particularly in a way that preserves the privacy of each individual user. In accordance with aspects of the subject disclosure, privacy preserving group member identification is provided, using a machine learning engine that operates locally on the user's device, using the content stored at the user's device.

Various ones of the electronic devices 102-107 may be single user devices or multi-user devices. Single user devices (e.g., electronic devices 106 and 107) may have a single user and may be associated with a single user account such as an individual user account with one or more of the servers 112-114. Multi-user devices (e.g., electronic devices 102, 103, 104, and 105) may provide functionality to switch the current state of the device between the individual user accounts of one or more users and/or a group account of a group of users. In one or more implementations, the electronic devices 102-107 may form part of a connected home environment 116, and the LAN 108 may communicatively (directly or indirectly) couple any two or more of the electronic devices 102-107 within the connected home environment 116. Moreover, the network 110 may communicatively (directly or indirectly) couple any two or more of the electronic devices 102-107 with the content provider 112 and/or the cloud-based service 114, for example, in conjunction with the LAN 108.

In one or more implementations, the LAN 108 may include one or more different network devices/network medium and/or may utilize one or more different wireless and/or wired network technologies, such as Ethernet, optical, Wi-Fi, Bluetooth, Zigbee, Powerline over Ethernet, coaxial, Ethernet, Z-Wave, cellular, or generally any wireless and/or wired network technology that may communicatively couple two or more devices.

In one or more implementations, the network 110 may be an interconnected network of devices that may include, and/or may be communicatively coupled to, the Internet. For explanatory purposes, the network environment 100 is illustrated in FIG. 1 as including electronic devices 102-107, and the servers 112-114; however, the network environment 100 may include any number of electronic devices and any number of servers.

One or more of the electronic devices 102-107 may be, for example, a portable computing device such as a laptop computer, a smartphone, a smart speaker, a peripheral device (e.g., a digital camera, headphones), a digital media player, a tablet device, a wearable device such as a smartwatch or a band, a connected home device, such as a wireless camera, a router and/or wireless access point, a wireless access device (e.g., a door lock), a smart thermostat, smart light bulbs, home security devices (e.g., motion sensors, door/window sensors, etc.), smart outlets, smart switches, and the like, or any other appropriate device that includes and/or is communicatively coupled to, for example, one or more wired or wireless interfaces, such as WLAN radios, cellular radios, Bluetooth radios, Zigbee radios, near field communication (NFC) radios, and/or other wireless radios.

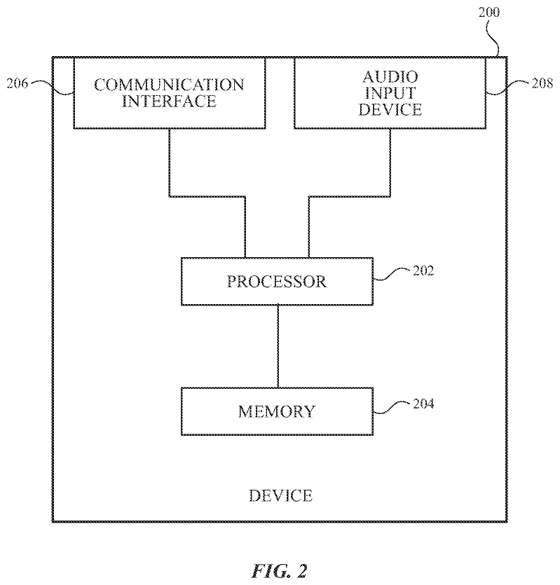

By way of example, in FIG. 1 each of the electronic devices 102-103 is depicted as a smart speaker, the electronic device 106 is depicted as a smartphone, the electronic device 107 is depicted as a smartwatch, and each of the electronic devices 104 and 105 is depicted as a digital media player (e.g., configured to receive digital data such as music and/or video and stream it to a display device such as a television or other video display). In one or more implementations, one or more of the electronic devices 104 and 105 may be integrated into its corresponding display device. One or more of the electronic devices 102-107 may be, and/or may include all or part of, the device discussed below with respect to FIG. 2, and/or the electronic system discussed below with respect to FIG. 8.

In one or more implementations, the electronic devices 102-105 may correspond to multi-user devices, which are associated with a home account and usable to provide content and/or respond to requests (e.g., voice requests) for multiple individual users associated with respective individual user accounts of the connected home environment 116 (e.g., authorized users), and/or for multiple group members of a group account associated with the connected home environment. One of more of the electronic devices 102-107 may be configured to receive user authorization to access respective user account profiles for single user accounts and/or group accounts, in order to provide access to content, applications, or storage within the connected home environment 116.

In one or more implementations, the electronic device 106 may correspond to a personal device associated with a user account (e.g., of a user named “Alison”). Alison may reside in or be a guest of the home/residence (e.g., corresponding to the connected home environment 116), which is also the home of another user (e.g., named “Bob”). The electronic device 107 may be associated with a user account for Bob, and the electronic devices 102-105 may correspond to a home account for Bob. For example, the respective users may register and/or associate their respective electronic devices 102-106 to their respective user accounts and/or to a group account of which they are a group member, through a service provider, such as through the cloud-based service 114.

In one or more implementations, Bob may interact with the electronic device 107 in order to access and/or output content (e.g., video and/or music available through Bob's content library associated with Bob's individual user account and/or with a group account for which Bob is a group member) on one or more of the electronic devices 102-105. For multi-user devices, Allison's individual user account may be associated with, and accessible on, one or more of the electronic devices 102-105 (e.g., the multi-user devices) in Bob's connected home environment 116 and/or Allison may be a group member of the same group (e.g., a family group) for which Bob is a group member. Thus, Alison may use her electronic device 106 as a remote control in order to output content (e.g., content that is provided by the content provider 112 in association with her content library) on one or more of the electronic devices 102-105.

Alternatively, or in addition, Alison may access her media content (e.g., music and/or video) on one or more of the electronic devices 102-105 without using her electronic device 106. For example, the electronic devices 102-103 (e.g., smart speakers) may have a virtual assistant application running thereon, and Alison may provide a voice request to stream music (e.g., via the content provider 112) in association with her individual user account (e.g., an individual content library) and/or a group account for which she is a group member (e.g., a group content library). In another example, the electronic devices 104-105 (e.g., digital media players) may have respective remote control devices that Alison can use (e.g., via physical button(s) and/or voice requests spoken to the remote) to output video and/or music via the content provider 112 in association with her individual user account and/or the group account.

Bob's device 107 and/or the electronic devices 102-105 may also provide access to content, storage, applications, etc. associated with a group account established by Bob with one or more of the servers 112-114. In accordance with one or more implementations, Bob's electronic device 107 may identify Allison as a potential group member for a new or existing group account of Bob, and may suggest to Bob to add Allison as a group member. For example, if Bob has a single user account with one or more of the servers 112-114, electronic device 107 may suggest that Bob establish a group with Allison when Allison is identified as a potential group member for Bob. In another example, if Bob already has an existing group account, electronic device 107 may suggest that Bob add Allison to Bob's existing group account when Allison is identified as a potential group member for Bob. Further details of the processes for identifying Allison as a potential group member are provided below.

Moreover, based on an invitation from Bob (e.g., via the electronic device 107) and acceptance by Alison (e.g., via the electronic device 106), Alison may be added to a group account of Bob (e.g., by obtaining user information for Allison to be added to Bob's group account and/or by linking Allison's individual user account to Bob's single user account or Bob's group account). In one or more implementations, a group account may have more than one primary user. For example, a group account may be shared by two primary users (e.g., Bob and Dave). In this example, based on an invitation from Bob or an invitation from Dave (e.g., via the electronic device 107) and acceptance by Alison (e.g., via the electronic device 106 or another electronic device associated with Dave), Alison may be added to a group account of Bob and Dave (e.g., by obtaining user information for Allison to be added to Bob and Dave's group account and/or by linking Allison's individual user account to Bob and Dave's group account).

In one or more implementations, the cloud-based service 114 may be configured to perform operations in association with individual user accounts and/or group accounts such as: storing data (e.g., voice profiles, user settings/preferences, files such as documents and/or photos, etc.) with respect to individual user accounts and/or group accounts, sharing and/or sending data with other users with respect to individual user accounts and/or group accounts, backing up device data with respect to individual user accounts and/or group accounts, and/or associating devices and/or groups of devices (e.g., within the connected home environment 116) with individual user accounts and/or group accounts.

One or more of the servers 112-114 may be, and/or may include all or part of the device discussed below with respect to FIG. 2, and/or the electronic system discussed below with respect to FIG. 8. Each of the servers 112-114 may include one or more servers, such as a cloud of servers. For explanatory purposes, a single server is shown and discussed with respect to various operations for each of the servers 112-114. However, these and other operations discussed herein may be performed by one or more servers, and each different operation may be performed by the same or different servers.

FIG. 2 illustrates an example device that may implement a system for identifying potential group members for a group account of a user in accordance with one or more implementations. For example, the device 200 of FIG. 2 can correspond to any of the electronic devices 102-107 and/or the servers 112-114 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The device 200 may include a processor 202, a memory 204, a communication interface 206 and an audio input device 208. The processor 202 may include suitable logic, circuitry, and/or code that enable processing data and/or controlling operations of the device 200. In this regard, the processor 202 may be enabled to provide control signals to various other components of the device 200. The processor 202 may also control transfers of data between various portions of the device 200. Additionally, the processor 202 may enable implementation of an operating system or otherwise execute code to manage operations of the device 200.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, in a case where the device 200 corresponds to one of the electronic devices 102-107, the memory 204 may store one or more components configured to operate a machine-learning engine, locally at the device 200, to identify one or more potential group members for a group account, using data stored locally in memory 204. Moreover, the audio input device 208 may include suitable logic, circuitry, and/or code for capturing audio input, such as voice requests. For example, the audio input device 208 may include one or more microphones and/or other devices for capturing audio input.

In one or more implementations, in a case where the device 200 corresponds to the cloud-based service, 114, the memory 204 may store user profile data (e.g., user profiles associated with individual and/or group accounts) and/or configuration settings associated with a home environment (e.g., the connected home environment 116).

The communication interface 206 may include suitable logic, circuitry, and/or code that enables wired or wireless communication, such as between any of the electronic devices 102-107 and/or the servers 112-114 over the network 110 (e.g., in conjunction with the LAN 108). The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, the audio input device 208, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

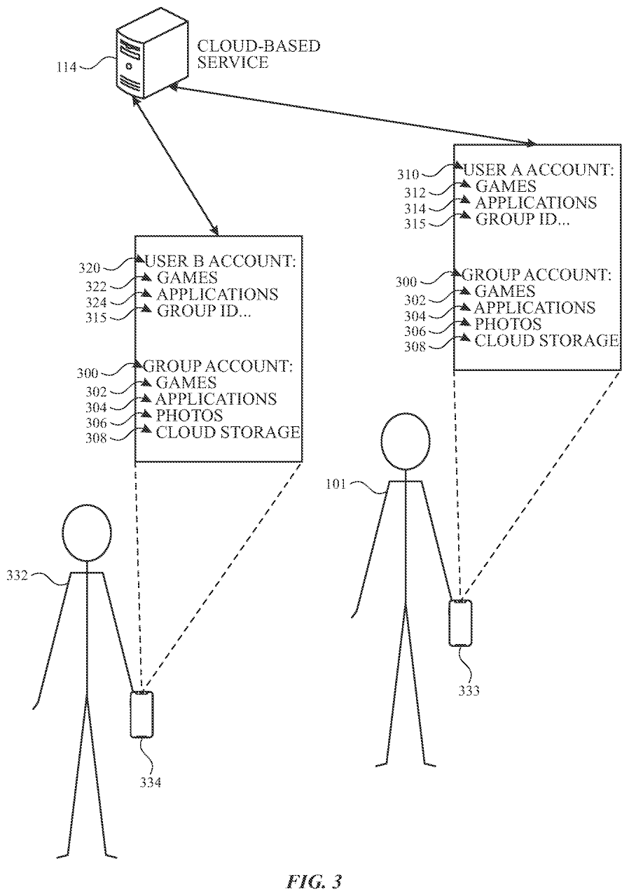

FIG. 3 illustrates an example of two users, each having a corresponding user device by which shared group content can be accessed. In the example of FIG. 3, user 101 may use electronic device 333 (e.g., an implementation of electronic device 106, electronic device 107, or electronic device 200 described herein) to access one or more accounts with cloud-based service 114, and user 332 may use electronic device 334 (e.g., an implementation of electronic device 106, electronic device 107, or electronic device 200 described herein) to access one or more accounts with cloud-based service 114. In this example, each of users 101 and 102 can access their own respective individual user accounts 310 and 320, and common group content, such as via a group identifier 315 that is associated with multiple individual user accounts and/or a common group account 300. As shown, a user with access to group account 300 can access one or more games 302, applications 304, photos 306, and cloud storage 308 associated with that group account. The games 302 and/or applications 304 that are associated with group account 300 may include some or all of the games 312 and 322 associated with the respective individual user accounts 310 and 320, and/or some or all of the applications 314 and/or applications 324 associated with the respective individual user accounts 310 and 320. In one or more implementations one or more of the games 312 and 322 associated with the respective individual user accounts 310 and 320 and/or one or more of the applications 314 and/or applications 324 associated with the respective individual user accounts 310 and 320 may only be accessible to the respective user 333 and 334 and not to the other of users 333 and 334 (e.g., in circumstances in which that user has declined to share access to one or more particular games or applications obtained with their own individual user account with the group).

In one or more implementations, group account 300 may be a data structure (e.g., a data structure that is associated with the group identifier 315) that stores an association between the individual user accounts 310 and 320. Once the association is established between the individual user accounts 310 and 320, either of users 101 and 332 may be provided with access to some or all of the games, applications, songs, movies, etc. purchased by the other of users 101 and 332 (e.g., and/or any other user with a user account that is associated with group account 300) using their respective individual user accounts 310 and 320 and/or via the common group account 300.

For example, if User A buys a game 312 using individual user account 310 (e.g., with electronic device 333), that game becomes associated with individual user account 310 and/or group identifier 315. If User B is part of a group with User A and wants to add that game on electronic device 334, User B may be provided with access to that game via group identifier 315 and/or group account 300. For example, when User B attempts to obtain that game with user device 334, user device 334 may display a notification such as, for example, “You can access this game through a purchase made by another member in your family”.

Portions of the information associated with group account 300 can be accessible to all members of the corresponding group, and/or other portions of the information associated with group account can be user specific. In one example, each of user accounts 310 and 320 can provide access to the same set of games 302 and applications 304, whether originally obtained using user account 310, user account 320, or group account 300. However, for some games and/or applications, cloud-based service 114 and/or electronic devices 333 and 334 may store profile information and/or configuration information separately for each group member (e.g., in association with the group account 300 and/or with the individual user accounts 310 and 320). In this way, each of users 101 and 332 can play the same game, accessed using group account 300, while the game progress, avatar or character selections, etc. are stored for each member in the group. Photos 306 may be stored in a group photo album that is accessible (e.g., for read and/or write of photos, videos, or the like) by all members in the group corresponding to group account 300. Cloud storage 308 may be a set amount of storage that can be used by the group corresponding to group account 300, and/or may be partitioned to include secure storage spaces for each member and/or for the entire group. Individual user accounts 310 and 320 may also include or be associated with individual photo albums and/or cloud storage that is not shared with other members of the group. In this way, and as illustrated in FIG. 3, each of users 101 and 332 can access user profile data, configuration settings, applications, content, and/or storage space associated with their own user accounts and/or associated with a common group account with cloud-based service 114.

In the example of FIG. 3, user 101 has an individual account 310 (represented as “User A Account” in FIG. 3) to which user 332 does not have access, and user 332 has an individual account 320 (represented as “User B Account” in FIG. 3) to which user 101 does not have access, even though access to some games, applications, etc. obtained using those individual user accounts can be shared between users 101 and 332. As shown, individual account 310 of user 101 is also associated with one or more games 312, applications, 314 etc., and individual account 320 of user 332 is associated with one or more games 322, applications 324, etc. The games 302, applications 304, etc. of the group account 300 for users 101 and 332, can include some or all of the games 312, applications 314, and/or other content that are accessible by user 101 using individual account 310 and/or the games 322, applications 324, and/or other content that are accessible by user 332 using individual account 320. In the example of FIG. 3, each of users 101 and 332 have access to group account 300 and a respective individual account. However, it should also be appreciated that some members of the group corresponding to group account 300 may not have an individual user account (e.g., a parent having a group account and an individual account may add a child to the group account with or without creating a separate individual user account for the child).

Each group and/or group account 300 may have one or more primary users, and one or more secondary users in one or more implementations. Group account 300 may be a family account for a family of users (e.g., for sharing access to applications, games, etc. across the family, such as for a group account where one parent or two parents can act as primary users for the group account), a co-worker account for a group of co-workers (e.g., for sharing access to common work-related applications and/or data), a friends group, and/or any other suitable group of users of a common set of applications, storage, content, etc.

In order to facilitate the formation and/or growth of the groups for a group account, while maintaining the privacy of each user, a user's device may be provided with the ability to identify potential group members for a group including that user, using the data that is stored locally at that user's device. The local data may include a list of contacts, designation information for those contacts, interaction information for those contacts, and/or other information stored locally at the user's device for those contacts. Once one or more potential group members have been identified locally at the user's device (e.g., from within the user's contacts), the user's device may provide an option to the user to form a new group with the identified potential group member or invite and/or add the identified potential group member to an existing group.

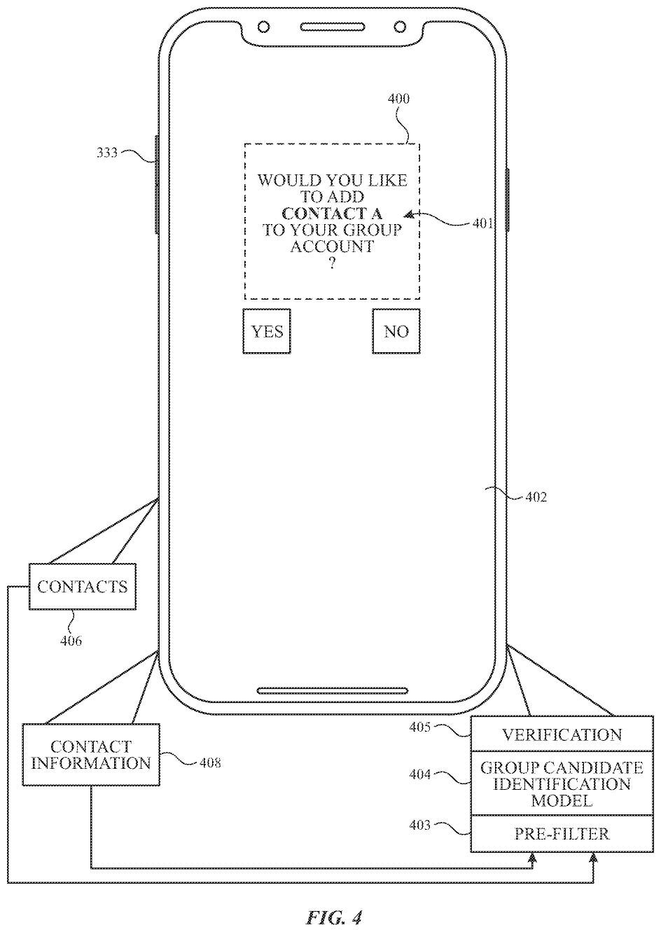

FIG. 4 illustrates an example of a suggestion of a potential group member that can be provided to a user of electronic device 333. In the example of FIG. 4, an option 400 to include a potential group member 401 (e.g., CONTACT A) in a group is provided on a display 402 of electronic device 333. In this example, the option 400 includes a text-based suggestion including the text “Would you like to add CONTACT A to your group account?”, along with selectable options to add (“Yes”) or decline to add (“No”) the suggested group member CONTACT A to the group. In other operational scenarios, the user of electronic device 333 may not yet have established a group account and the text of option 400 may be modified to ask the user if they would like to create a new group account for the user and the suggested group member CONTACT A. In other operational scenarios, the suggestion(s) of one or more potential group members may be provided in other ways (e.g., using an audio suggestion, a graphical (e.g., non-text) suggestion, or any other suitable process for providing a suggested group member to the user of electronic device 104 and/or any other electronic device).

FIG. 4 also illustrates that electronic device 333 may include a machine learning model such as a group candidate identification model 404 that has been trained to identify potential group members for a group account of the user of electronic device 333, using local information at electronic device 333. In this example, electronic device 333 stores contacts 406 and contact information 408. The contacts 406 and/or the contact information 408 may be provided to the trained group candidate identification model 404 to obtain one or more potential or suggested group members from the contacts 406. For example, the output of the group candidate identification model 404 may be a binary label for each contact 406 for which contact information 408 was provided to the model. Although group candidate identification model 404 is depicted as a single machine learning model in FIG. 4, it should be appreciated that group candidate identification model 404 can incorporate an ensemble of models that provide outputs that can be merged to output one or more potential group members.

As shown in FIG. 4, in one or more implementations, electronic device 333 may include a pre-filter 403 that pre-filters the contact 406 and/or the contact information 408 prior to providing the contacts and/or the contact information to the group candidate identification model 404. For example, pre-filter 403 may reduce the number of contacts 406 (and the associated contact information 408) that are provided to the group candidate identification model 404, based on the contact information 408. For example, pre-filter 403 may filter contacts without any interactions (e.g., any calls, messages, proximity based events, or other communications such as within a recent period of time for which the calls, messages, proximity based events, etc. have been logged at electronic device 333) with electronic device 333 out of a list of contacts (and associated contact information) that is provided to the group candidate identification model 404.

Pre-filter 403 and/or other components and/or processors at electronic device 333 may also, and/or alternatively, pre-process the contact information 408 and/or the contacts 406 to extract specific contact features from the contact information, and to arrange the extracted contact information for input to the group candidate identification model 404.

Contact information 408 may include contact features in various categories of features for one or more of contacts 406 in the electronic device 333, for which evidence of the presence of these features can be found at electronic device 333. For example, data associated with contacts 406 and/or activity at the electronic device 333 can be pre-processed to form contact information 408, which may include interaction features that describes interactions (e.g., over a predetermined period of time such as over the preceding week, weeks, month, months, six months, year, or years), and/or contact profile features that describe stored features of one or more of the contacts. The interaction information and/or the contact profile information may be extracted from the data stored at electronic device 333 and/or provided to the group candidate identification model 404 to obtain one or more potential group members from the model.

The contact information 408 may also include explicit trust signals that can be used to verify the potential group members provided by the model, prior to suggesting the model-provided potential group members to the user. The explicit trust signals (also referred to herein as explicit user trust data) can be provided to group candidate identification model 404 as part of the input data to the model and/or that can be used by a (e.g., optional) verification module 405 to verify that one or more of the suggested group members from group candidate identification model 404 are trusted potential group members.

The explicit trust signals can include, for example, location information and/or time information. As illustrative examples, the location information may include co-habitation information or co-working information. For example, the co-habitation information may be generated based on proximity signals between electronic device 333 and another user's device (such as electronic device 334 of FIG. 2), such as during specific time periods (e.g., in the evenings after working hours and/or in the mornings prior to working hours). For example, the co-working information may be generated based on proximity signals between electronic device 104 and another user's device (such as electronic device 334 of FIG. 2), such as during other specific time periods (e.g., during working hours). The proximity signals may include Bluetooth beacons and/or NFC communications between the electronic device 333 and the electronic device 334, such as NFC transfers of contact information or other data such as photos or files.

The interaction information may include information associated with a social graph of the user (e.g., based on historical social interactions between the user and various contacts, as indicated by the data stored at the electronic device 333). For example, the interaction information may include, for each contact of a user, a total number of calls between the user and the contact, a duration of each call between the user and the contact, and/or or a total number of calls of (e.g., at least) a particular duration between the user and the contact. The particular duration may be defined relative to an average duration of calls to and/or from the electronic device 333 (e.g., a duration that is twice the average duration of all calls to and/or from the device). As another example, the interaction information may include, for each contact, a statistical description (e.g., an average, a standard deviation, a minimum, a maximum, or a median) of the number of calls (e.g., incoming calls and/or outgoing calls) between the user and the contact over a period of time (e.g., per week, per day, etc.). As another example, the interaction information may include, for each contact, a ratio of a number of days on which a call to and/or from the contact was made, to a total number of days logged.

As another example, the interaction information may include, for each contact, a ratio of a number and/or a duration of outgoing calls to the contact, to the number and/or duration of all calls to and/or from the electronic device. As another example, the interaction information may include, for each contact, a ratio of a number and/or a duration of calls to or from the contact during predetermined periods of time (e.g., time periods within a day and/or days within a week), to the number and/or duration of all calls to and/or from the electronic device. As another example, the interaction information may include, for each contact, a ratio of a number of calls greater than a predetermined length (e.g., within predetermined periods of time), to the number and/or duration of all calls to and/or from the electronic device. As another example, the interaction information may include, for each contact, a ratio of a number and/or a duration of calls over a recent period of time (e.g., over the preceding week, two weeks, several weeks, month, two months, three months, etc.), to the number and/or duration of all calls to and/or from the electronic device. As another example, the interaction information may include, for each contact, a total number of messages to and/or from the contact. As another example, the interaction information may include, for each contact, a statistical description (e.g., an average, a standard deviation, a minimum, a maximum, or a median) of the number of messages (e.g., incoming messages and/or outgoing messages) between the user and the contact over a period of time (e.g., per week, per day, etc.). As another example, the interaction information may include, for each contact, a number of days on which a message to and/or from the contact was exchanged, to a total number of days on which messages were logged.

As another example, the interaction information may include, for each contact, a ratio of a number of outgoing messages to the contact, to the number all messages to and/or from the electronic device. As another example, the interaction information may include, for each contact, a ratio of a number of replied messages, to the number of all messages to and/or from the electronic device. As another example, the interaction information may include, for each contact, a ratio of a number of messages to or from the contact during predetermined periods of time (e.g., time periods within a day and/or days within a week), to the number of all messages to and/or from the electronic device. As another example, the interaction information may include, for each contact, a ratio of a number of messages over a recent period of time (e.g., over the preceding week, two weeks, several weeks, month, two months, three months, etc.) to the number of all messages to and/or from the electronic device.

The number of calls to and/or from particular contacts, the total number of calls to and/or from a device, the number of messages to and/or from particular contacts, the total number of messages to and/or from the device, and/or ratios and/or statistical descriptions of these values may be determined (e.g., logged and/or computed) over a common recent period of time such as over the week, two weeks, several weeks, month, two months, three months preceding the time of analysis. Electronic device 333 may log and/or store call and/or message data over the common recent period of time, in various time segments, such as in hourly segments and/or day-of-week segments. The hourly segments may include, for example, a morning segment (e.g., from 6 AM until 12 PM), an afternoon segment (e.g., from 12 PM until 6 PM), an evening segment (e.g., from 6 PM until 12 AM), and a night segment (e.g., from 12 AM until 6 AM). The day-of-week segments may include, for example, a segment for each day of the week, or four day-of-week segments such as a weekdays segment (e.g., including Monday through Thursday), a Friday segment, a Saturday segment, and a Sunday segment. Logging and/or storing the calls and/or messaging in the various time segments can facilitate determining various aspects of the interaction information described above to form input data for the group candidate identification model 404.

The contact profile information may include attributes of one or more contacts that have been added by the user of the electronic device. The attributes may include, for example, an identification, at the electronic device 104, that a contact is an emergency contact for the user. As another example, these attributes may include an identification of a contact in connection with a connected home environment in common with the user. The contact profile information may include a feature (e.g., a flag value such as a binary feature) that indicates that the family name (e.g., surname) of a contact is the same as the family name of the user. The contact profile information may include a feature (e.g., a flag value such as a binary feature) that indicates that a contact is designated as a parent of the user (e.g., based on a contact name including a variant of “mom”, “dad”, “mother”, or “father” or another designator of a parent stored at the device). The contact profile information may include a feature (e.g., a flag value such as a binary feature) that indicates that a contact is a designated as a favorite contact at the electronic device. The contact profile information may include a feature (e.g., a flag value such as a binary feature) that indicates that the location of the electronic device has been shared with a contact and/or that the location of one or more electronic devices of a contact has been shared with the electronic device.

The contact profile information may include a feature (e.g., a flag value such as a binary feature) that indicates a call between the user and a contact, on a birthday of the user and/or on a birthday of the contact, where the birthday(s) are stored at the electronic device. The contact profile information may include a feature (e.g., a flag value such as a binary feature) that indicates that a contact is designated, at the electronic device, as an emergency contact for the user. The contact profile information may include a feature (e.g., a flag value such as a binary feature) that indicates that a contact has been designated with “family relationship” label at the electronic device. For example, a parent may add a new contact for their child and label the contact with a family relationship label (e.g., a daughter, a son, a child, etc.), or a contact may be added for any other family member and labeled as a generic family member or a specific family member (e.g., cousin, sibling, grandparent, aunt, uncle, etc.). The contact profile information may include a feature (e.g., a flag value such as a binary feature) that indicates that the contact is present in one or more photos stored at the electronic device (e.g., as marked by the user, such as in connection with photo album and/or a home application for the connected home network of the user, or as predicted by a computer vision model at the electronic device). The contact profile information may include a feature (e.g., a flag value such as a binary feature) that indicates that the contact is a member of a connected home environment in common with the user.

The interaction information, the contact profile information and/or the explicit trust signals can be combined (e.g., by pre-filter 403) into a vector, an array, a tensor or other data structure that can be provided as input to the group candidate identification model 404.

The group candidate identification model 404 may be trained based on training data that includes user-contact interaction data for training contacts and a training user. For example, the training data may be obtained from anonymized contacts and contact information for a set of training users. The training data may include anonymized interaction information, contact profile information and/or explicit trust signals for the training users.

Training data may include, for example, a binary label for each training contact based on whether they are part of a training user's group. Thus, for every training user, a training dataset can be provided in which, for example, each row of the training data corresponds to the feature representation for a single contact, and a binary label indicating whether the contact is part of the training user's group.

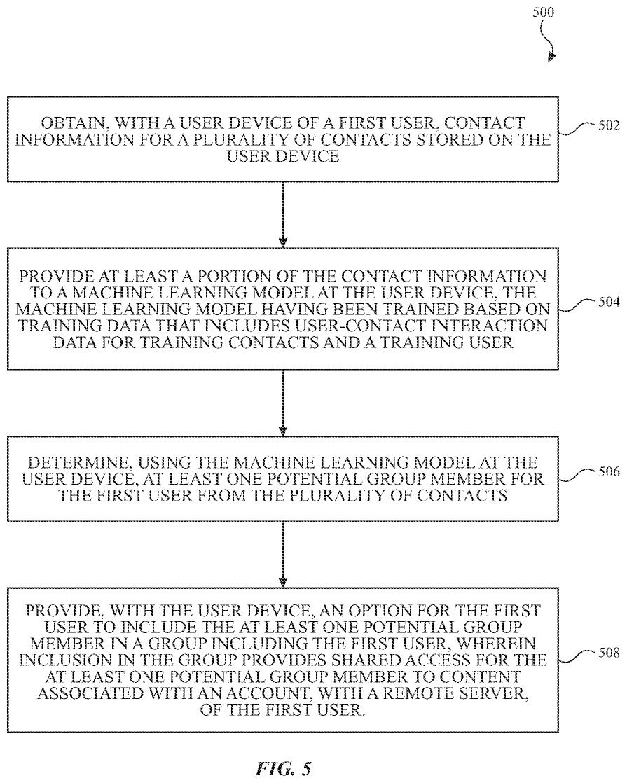

FIG. 5 illustrates a flow diagram of an example process 500 for identifying a potential group member for a group of a user in accordance with one or more implementations. For explanatory purposes, the process 500 is primarily described herein with reference to the electronic devices 333 and 334, and the cloud-based service 114 of FIGS. 1 and 2. However, the process 500 is not limited to the electronic devices 333 and 334, and the cloud-based service 114 of FIGS. 1 and 2, and one or more blocks (or operations) of the process 500 may be performed by one or more other components of the cloud-based service 114 and other suitable devices. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, a user device of a first user, such as electronic device 333 of user 101 as described above in connection with FIG. 2, obtains contact information for one or more contacts, such as a list of contacts, such as contacts 406, stored on the user device.

At block 504, at least a portion of the contact information may be provided to a machine learning model (e.g., the group candidate identification model 404) at the user device, the machine learning model having been trained based on training data that includes user-contact interaction data for training contacts and a training user. Providing the portion of contact information may include pre-processing the list of contacts to identify a subset of the contacts to provide to the machine-learning model. The contact information may then be extracted for the subset of the contacts. The contact information may include at least one of interaction information, contact profile information, and explicit user trust signals as described herein.

In one or more implementations, the user device may pre-filter the list of contacts prior to providing at least the portion of the contact information to the machine learning model. Pre-filtering the list of contacts may include obtaining contacts from the list of contacts that have had at least one interaction with the first user over a predetermined amount of time (e.g., over the preceding several months, such as over the preceding six months). Pre-filtering the list of contacts may also, or alternatively, include pre-filtering the list of contacts based on a type of the group. As discussed herein, the type of the group may include a family group, a coworker group, a friends group, or a medical information sharing group. Pre-filtering based on the type of group may include filtering the contacts based on time and proximity information as described herein (e.g., by determining that the user's device is commonly co-located with another user's device in the morning and evening hours, for a family group).

Although the list of contacts may be pre-filtered to remove contacts with zero interactions with the first user over the predetermined amount of time, from the contacts that are provided to the machine learning model, the training data may include user-contact interaction data for training contacts with zero interactions with the training user over the predetermined amount of time. Including training contacts with zero interactions in the training data can help reduce false positive identifications of potential group members, whether or not contacts with zero interactions are included in the input to the trained model.

At block 506, the user device determines, using the machine learning model at the user device, at least one potential group member for the first user from the list of contacts. In one or more implementations, the user device may initiate the process of identifying a potential group member for the user when the user downloads or opens an application that can be accessed via a group account, or responsive to another trigger (e.g., a time-based trigger) generated at the user device.

In one or more implementations, the user device may initiate the process of identifying a potential group member responsive to a trigger from a remote server such as cloud-based service 114. For example, in one or more implementations, prior to determining the at least one potential group member, the remote server may identify the first user as a candidate group member (e.g., a candidate for establishing the group) at the remote server. For example, identifying the first user as the candidate may include identifying payment information for the first user that is stored at the remote server and that is shared with another user of the remote server. For example, the remote server may perform a blind credit card match that indicates that the first user and the other user of the remote server have each made a purchase with the same credit card, without being able to identify the credit card number or the identity of the other user of the remote server. The remote server may also identify a candidate group member using a blind surname match or a blind address match. Because the remote server cannot identify the other user (e.g., only that one may exist), the remote server then provides an indication to the user device that the first user is or may be a candidate group member (e.g., that the first user may be associated with the other user and/or that the first user may want to and/or be candidate to establish a group), which can trigger the user device to perform the operations of blocks 502, 504, and 506, to identify one or more potential group members for the candidate group member. In this way, determining the at least one potential group member may be performed responsive to a notification from the remote server to the user device that the first user is a candidate group member (e.g., in scenarios in which the first user is not already a member of a group).

At block 508, the user device may provide an option for the first user to include the at least one potential group member in a group including the first user. Providing the option may include providing a suggestion, such as the suggestion provided in option 400 of FIG. 4, to include the at least one potential group member in a group, and one or more selectable options to accept or decline the suggestion. Inclusion in the group provides shared access for the at least one potential group member to content, games, applications, photos, and/or cloud storage, associated with an account, with a remote server (e.g., cloud-based service 114), of the first user, and provides the first user with access to content, games, etc. associated with the potential group member's account.

Providing the option for the first user to include the at least one potential group member in the group may include an option to establish the group including the first user and the at least one potential group member, or may include an option to add the at least one potential group member to an existing group including the first user and at least one additional user.

In one or more implementations, prior to providing the option for the first user to establish the group including the first user and the at least one potential group member, the user device may confirm, based on explicit user trust data stored at the user device, that the at least one potential group member that has been provided by the machine learning model is a trusted potential group member. In these implementations, the explicit trust data is used to confirm the at least one potential group member that has been provided by the machine learning engine. For example, prior to providing the option to add the at least one potential group member suggested by the machine leaning engine to the first user, the user device may confirm that the at least one potential group member has been within the proximity (e.g., within NFC communications proximity) of the user device (e.g., at least a minimum number of times, with at least a minimum frequency, and/or within one or more particular periods of time), and/or that the at least one potential group member is listed in a “favorites” list of the contacts on the user device. In one or more other implementations the explicit user trust data stored at the user device can be provided to the machine learning engine together with at least the portion of the list of contacts so that the at least one potential group member that is provided by the machine learning engine is more likely to be a trusted potential group member (e.g., without then performing a separate verification operation).

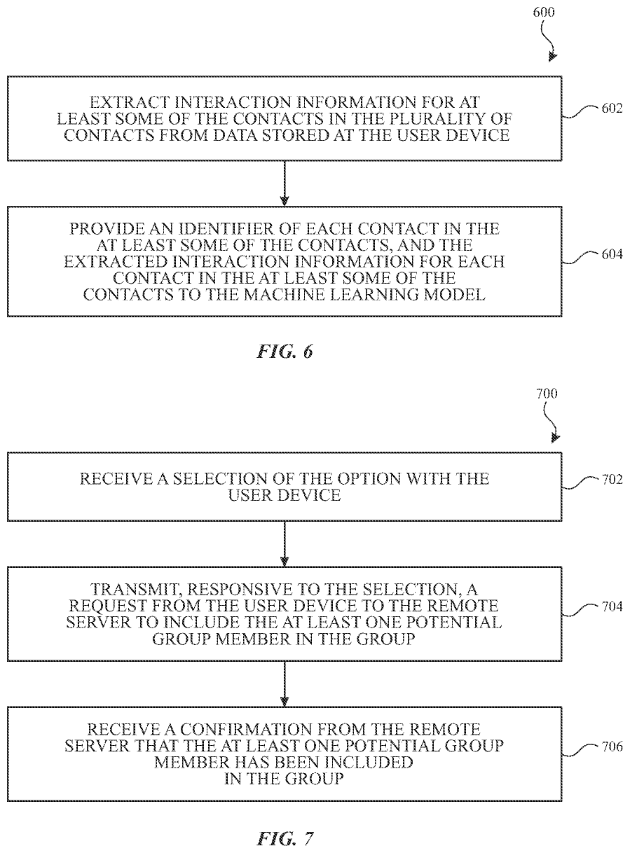

FIG. 6 illustrates a flow diagram of an example process 600 for providing a portion of contact information for a list of contacts to a machine learning model in accordance with one or more implementations. For explanatory purposes, the process 600 is primarily described herein with reference to the electronic devices 333 and 334, and the cloud-based service 114 of FIGS. 1 and 2. However, the process 600 is not limited to the electronic devices 333 and 334, and the cloud-based service 114 of FIGS. 1 and 2, and one or more blocks (or operations) of the process 600 may be performed by one or more other components and/or other suitable devices (e.g., any of the electronic devices 102-107). Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, a user device such as electronic device 104 may extract interaction information for each of at least some of the contacts in the list of contacts from data stored at the user device. The user device may also extract contact profile information for each of the at least some of the contacts in the list of contacts from data stored at the user device. The user device may also extract explicit trust signals for each of the contacts in the list of contacts from data stored at the user device.

At block 604, the user device may provide an identifier of each contact in the at least some of the contacts, and the extracted interaction information for each contact in the at least some of the list of contacts to the machine learning model (e.g., the group candidate identification model 404). The user device may also provide the extracted contact profile information and/or the extracted explicit trust signals to the machine learning model.

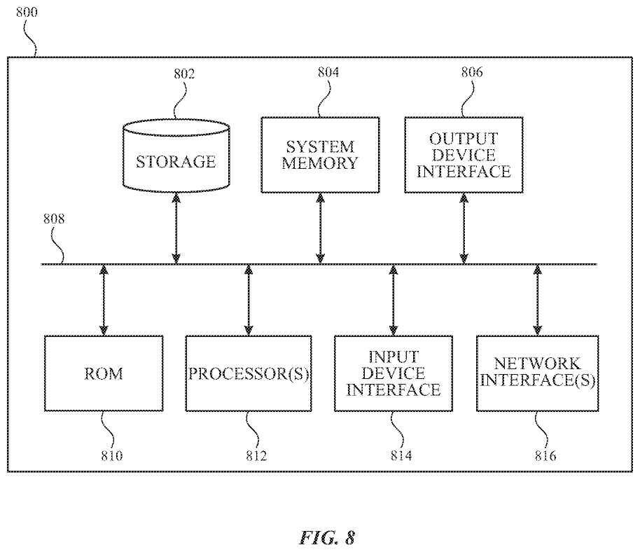

FIG. 7 illustrates a flow diagram of an example process 700 for including at least one potential group member that has been suggested by an electronic device, in a group, in accordance with one or more implementations. For explanatory purposes, the process 700 is primarily described herein with reference to the electronic devices 333 and 334, and the cloud-based service 114 of FIGS. 1 and 2. However, the process 700 is not limited to the electronic devices 333 and 334, and the cloud-based service 114 of FIGS. 1 and 2, and one or more blocks (or operations) of the process 700 may be performed by one or more other components and/or other suitable devices (e.g., any of the electronic devices 102-107). Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, a selection of the option (e.g., option 400 of FIG. 3) is received with the user device (e.g., electronic device 333). Receiving the selection of the option may include, for example, receiving a touch input at a virtual “Yes” button, or another indication of acceptance of the suggestion corresponding to option 400.

At block 704, the user device (e.g., electronic device 333) may transmit, responsive to the selection, a request from the user device to the remote server (e.g., cloud-based service 114) to include the at least one potential group member (e.g., CONTACT A) in the group. The request may include an identifier (e.g., a telephone number, a name, etc.) of the at least one potential group member. The remote server may, for example, send an invitation to another electronic device (e.g., electronic device 334) of the at least one potential group member to join the group. Prior to including the at least one potential group member in the group, the remote server may receive consent (e.g., a positive response to the invitation) from the potential group member.

In another implementation, the invitation may be provided directly from the electronic device to the other electronic device of the at least one potential group member, and the request to the remote server to include the at least one potential group member in the group may be sent from the electronic device of the user or the other electronic device of the at least one potential group member to the remote server (e.g., including authorization information from both the user and the at least one potential group member to include the at least one potential group member in the group).

Including the at least one potential group member in the group, at the remote server, may include associating an identifier of the at least one potential group member and/or an identifier of the other electronic device (e.g., electronic device 334) with a group account corresponding to the group. Including the at least one potential group member in the group, at the remote server, may include providing access, by the user and the at least one potential group member, to one or more games (e.g., games 302), one or more applications (e.g., applications 304), one or more shared photo albums (e.g., including photos 306), and/or at least a portion of a shared cloud storage space (e.g., cloud storage 308).

At block 706, electronic device 104 may receive a confirmation from the remote server that the at least one potential group member has been included in the group.

As described above, one aspect of the present technology is the gathering and use of data available from specific and legitimate sources for identifying a potential group member for a group of a user. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for identifying a potential group member for a group of a user. Accordingly, use of such personal information data may facilitate transactions (e.g., on-line transactions). Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of responding to a user request using a multi-user device within a home environment, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 8 illustrates an electronic system 800 with which one or more implementations of the subject technology may be implemented. The electronic system 800 can be, and/or can be a part of, one or more of the electronic devices 102-107, the content provider 112 and/or the cloud-based service 114 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the content provider 112 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

In accordance with aspects of the disclosure, a method is provided that includes obtaining, with a user device of a first user, contact information for a plurality of contacts stored on the user device; providing at least a portion of the contact information to a machine learning model at the user device, the machine learning model having been trained based on training data that includes user-contact interaction data for training contacts and a training user; determining, using the machine learning model at the user device, at least one potential group member for the first user from the plurality of contacts; and providing, with the user device, an option for the first user to include the at least one potential group member in a group including the first user, where inclusion in the group provides shared access for the at least one potential group member to content associated with an account, with a remote server, of the first user.

In accordance with aspects of the disclosure, a non-transitory machine-readable medium is provided storing instructions that, when executed by one or more processors, cause the one or more processors to perform operations that include obtaining, with a user device of a first user, contact information for a plurality of contacts stored on the user device; providing at least a portion of the contact information to a machine learning model at the user device, the machine learning model having been trained based on training data that includes user-contact interaction data for training contacts and a training user; determining, using the machine learning model at the user device, at least one potential group member for the first user from the plurality of contacts; and providing, with the user device, an option for the first user to include the at least one potential group member in a group including the first user, where inclusion in the group provides shared access for the at least one potential group member to content associated with an account, with a remote server, of the first user.

In accordance with aspects of the disclosure, an electronic device is provided that includes memory, and one or more processors, where the one or more processors are configured to obtain contact information for a plurality of contacts stored on in the memory; provide at least a portion of the contact information to a machine learning model at the electronic device, the machine learning model having been trained based on training data that includes user-contact interaction data for training contacts and a training user; determine, using the machine learning model at the electronic device, at least one potential group member for a group including a user of the electronic device, from the plurality of contacts; and provide an option for the user to include the at least one potential group member in the group including the user, where inclusion in the group provides shared access for the at least one potential group member to content associated with an account, with a remote server, of the user.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, with a user device of a first user, contact information for a plurality of contacts stored on the user device;
providing at least a portion of the contact information to a machine learning model at the user device, the machine learning model having been trained based on training data that includes user-contact interaction data for training contacts and a training user;
determining, using the machine learning model at the user device, at least one potential group member for the first user from the plurality of contacts; and
providing, with the user device, an option for the first user to include the at least one potential group member in a group including the first user, wherein inclusion in the group provides shared access for the at least one potential group member to content associated with an account, with a remote server, of the first user.

2. The method of claim 1, further comprising:
prior to determining the at least one potential group member, identifying the first user as a candidate for establishing the group at the remote server.

3. The method of claim 2, wherein identifying the first user as the candidate comprises identifying payment information for the first user that is stored at the remote server and that is shared with another user of the remote server.

4. The method of claim 2, wherein the determining of the at least one potential group member comprises determining the at least one potential group member responsive to a notification from the remote server to the user device that the first user is the candidate for establishing the group.

5. The method of claim 1, further comprising, at the user device, pre-filtering the plurality of contacts prior to providing at least the portion of the contact information to the machine learning model.

6. The method of claim 5, wherein pre-filtering the plurality of contacts comprises pre-filtering the plurality of contacts based on a type of the group.

7. The method of claim 6, wherein the type of the group comprises a family group, a coworker group, a friends group, or a medical information sharing group.

8. The method of claim 6, wherein pre-filtering the plurality of contacts comprises obtaining contacts from the plurality of contacts that have had at least one interaction with the first user over a predetermined amount of time.

9. The method of claim 8, wherein the training data includes user-contact interaction data for training contacts with zero interactions with the training user over the predetermined amount of time.

10. The method of claim 8, wherein pre-filtering the plurality of contacts further comprises obtaining contacts from the plurality of contacts that include a family relationship label.

11. The method of claim 1, further comprising, prior to providing the option for the first user to establish the group including the first user and the at least one potential group member, confirming, with the user device based on explicit user trust data stored at the user device, that the at least one potential group member provided by the machine learning model is a trusted potential group member.

12. The method of claim 1, wherein providing at least the portion of the contact information to the machine learning model at the user device comprises:
extracting interaction information, for at least some of the contacts in the plurality of contacts, from data stored at the user device; and
providing an identifier of each contact in the at least some of the contacts, and the extracted interaction information for each contact in the at least some of the contacts to the machine learning model.

13. The method of claim 1, wherein providing the option for the first user to include the at least one potential group member in the group comprises an option to establish the group including the first user and the at least one potential group member.

14. The method of claim 1, wherein providing the option for the first user to include the at least one potential group member in the group comprises an option to add the at least one potential group member to an existing group including the first user and at least one additional user.

15. The method of claim 1, further comprising:
receiving a selection of the option with the user device;
transmitting, responsive to the selection, a request from the user device to the remote server to include the at least one potential group member in the group; and
receiving a confirmation from the remote server that the at least one potential group member has been included in the group.

16. A non-transitory machine-readable medium storing instructions that, when executed by one or more processors, cause the one or more processors to perform operations that include:
obtaining, with a user device of a first user, contact information for plurality of contacts stored on the user device;
providing at least a portion of the contact information to a machine learning model at the user device, the machine learning model having been trained based on training data that includes user-contact interaction data for training contacts and a training user;
determine, using the machine learning model at the user device, at least one potential group member for the first user from the plurality of contacts; and
providing, with the user device, an option for the first user to include the at least one potential group member in a group including the first user, wherein inclusion in the group provides shared access for the at least one potential group member to content associated with an account, with a remote server, of the first user.

17. The non-transitory machine-readable medium of claim 16, wherein the contact information comprises at least one of interaction information, contact profile information, and explicit user trust signals.

18. The non-transitory machine-readable medium of claim 17, wherein providing at least the portion of the contact information to the machine learning model at the user device comprises:
extracting interaction information for at least some of the contacts in the plurality of contacts from data stored at the user device; and
providing an identifier of each contact in the at least some of the contacts, and the extracted interaction information for each contact in the at least some of the contacts to the machine learning model.

19. The non-transitory machine-readable medium of claim 17, the operations further comprising:
receiving a selection of the option with the user device;
transmitting, responsive to the selection, a request from the user device to the remote server to include the at least one potential group member in the group; and
receiving a confirmation from the remote server that the at least one potential group member has been included in the group.

20. An electronic device, comprising:
memory; and
one or more processors, wherein the one or more processors are configured to:
obtain contact information for a plurality of contacts stored on in the memory;
providing at least a portion of the contact information to a machine learning model at the electronic device, the machine learning model having been trained based on training data that includes user-contact interaction data for training contacts and a training user;
determine, using the machine learning model at the electronic device, at least one potential group member for a group including a user of the electronic device, from the plurality of contacts; and
provide an option for the user to include the at least one potential group member in the group including the user, wherein inclusion in the group provides shared access for the at least one potential group member to content associated with an account, with a remote server, of the user.

21. The electronic device of claim 20, wherein the one or more processors is further configured to pre-filter the plurality of contacts prior to providing at least the portion of the contact information to the machine learning model.

22. The electronic device of claim 21, wherein the one or more processors is further configured to pre-filter the plurality of contacts by pre-filtering the plurality of contacts based on a type of the group.

23. The electronic device of claim 21, wherein the one or more processors is further configured to pre-filter the plurality of contacts by obtaining contacts from the plurality of contacts that have had at least one interaction with the user over a predetermined amount of time.
